(19) United States
(12) Patent Application Publication
(10) Pub. No.: US 2017/0235804 A1
(43) Pub. Date: Aug. 17, 2017

(54) System and method for visual construction of spatio-temporal expressions

(71) Applicant: International Business Machines Corporation, Armink, NY (US)

(72) Inventors: Jonathan Bnayahu, Haifa (IL); Alexander Kofman, Haifa (IL); Eli Packer, Givataim (IL); Tali Yatzkar-Haham, Misgav (IL)

(21) Appl. No.: 15/045,275

(22) Filed: Feb. 17, 2016

(51) Int. Cl. G06F 17/30; G06F 3/0482

(52) U.S. Cl. CPC G06F 17/30572; G06F 17/30241; G06F 3/0482; G06F 17/30604

(57) ABSTRACT

Visual construction of spatial or spatio-temporal relationships is disclosed. A method according to the disclosed subject matter may comprise receiving a visual representation of rule, the visual representation comprising two or more objects. A spatial relationship appearing in the visual representation may be analyzed and multiple alternative textual representations for the spatial relationship may be determined. A user selection between the multiple alternative textual representations of the spatial relationship may be received, whereby obtaining a selected verbalization of the relationship. A verbalization of the rule, which comprises the verbalization of the relationship, may be generated.

### TECHNICAL FIELD

The present disclosure relates to expressing spatiotemporal relations, in general and describing such relations for usage in computer programs, in particular.

### BACKGROUND

Computer applications are currently being executed by computing platforms such as servers, personal computers, laptops, mobile phones, smartphones and other fixed or mobile devices.

Many of these applications are created by combining computer programming skills on one hand with domain expertise on the other hand, where these two sets of skills are often offered by different professionals. Thus, the programmers are sometime unaware of, or at least not experts in the domain and provide general purpose tools or platforms that require specific information about the domain. On the other hand, the domain experts are not programmers and may provide their input as text, diagrams, natural language, simple formal language with limited expressive capabilities or other manners.

In many applications, the domain expertise includes spatial or spatio-temporal relations between objects, such as which object is next to or within another object at different points in time, or the like. Such relations are hard to describe efficiently using everyday tools, especially when complex, resulting in suboptimal applications, longer development time, and other deficiencies.

There is thus a need for a system and method for a method and system that provide for developing faster and more robust applications that involve a spatio-temporal aspect.

### BRIEF SUMMARY

One exemplary embodiment of the disclosed subject matter is a computer-implemented method comprising: receiving a visual representation of rule, the visual representation comprising two or more objects; analyzing a spatial relationship appearing in the visual representation of the rule, wherein said analyzing comprises determining multiple alternative textual representations for the spatial relationship, receiving from a user a selection between the multiple alternative textual representations of the spatial relationship, whereby obtaining a selected verbalization of the relationship; and generating a verbalization of the rule, wherein the verbalization comprises the selected verbalization of the relationship.

Another exemplary embodiment of the disclosed subject matter is a computer program product comprising a non-transitory computer readable storage medium retaining program instructions, which program instructions when read by a processor, cause the processor to perform a method comprising: receiving a visual representation of rule, the visual representation comprising two or more objects; analyzing a spatial relationship appearing in the visual representation of the rule, wherein said analyzing comprises determining multiple alternative textual representations for the spatial relationship; receiving from a user a selection between the multiple alternative textual representations of the spatial relationship, whereby obtaining a selected verbalization of the relationship; and generating a verbalization of the rule, wherein the verbalization comprises the selected verbalization of the relationship.

Yet another exemplary embodiment of the disclosed subject matter is a computer program product comprising a non-transitory computer readable storage medium retaining program instructions, which program instructions when read by a processor, cause the processor to perform a method comprising: receiving a visual representation of rule, the visual representation comprising two or more objects; analyzing a spatial relationship appearing in the visual representation of the rule, wherein said analyzing comprises determining multiple alternative textual representations for the spatial relationship; receiving from a user a selection between the multiple alternative textual representations of the spatial relationship, whereby obtaining a selected verbalization of the relationship; and generating a verbalization of the rule, wherein the verbalization comprises the selected verbalization of the relationship.

### THE BRIEF DESCRIPTION OF THE SEVERAL VIEWS OF THE DRAWINGS

The present disclosed subject matter will be understood and appreciated more fully from the following detailed description taken in conjunction with the drawings in which corresponding or like numerals or characters indicate corresponding or like components. Unless indicated otherwise, the drawings provide exemplary embodiments or aspects of the disclosure and do not limit the scope of the disclosure. In the drawings:

FIGS. 1A, 1B and 1C show exemplary user interfaces displaying exemplary relations between objects and corresponding rules or rule suggestions, in accordance with some exemplary embodiments of the subject matter;

FIG. 2 shows a flowchart diagram of a method for describing spatio-temporal relations, in accordance with some exemplary embodiments of the disclosure; and

FIG. 3 shows a block diagram of an apparatus for describing spatio-temporal relations, in accordance with some exemplary embodiments of the disclosed subject matter.

### DETAILED DESCRIPTION

One technical problem dealt with by the disclosed subject matter is the need to provide a platform for non-programmers which may be experts in or in charge of a domain involving spatio-temporal aspects to describe the spatio-temporal relations between objects.

Many modern applications executed by computers, mobile phones, smart phones or other platforms make use of spatio-temporal data as part of their business logic. Many of these applications, such as geographic applications, monitoring applications, design applications or others, comprise aspects related to spatial or spatio-temporal relations between objects, such as “object A is inside object B”, “Object A is at a distance exceeding 100 m from object B”, “Object A and object C are inside object B, and Object A is at a distance exceeding 100 m from object C”, “object A has entered object B and afterwards, object A has exited Object B”, or the like, wherein object A and object C may be, for example, persons and object B may be, for example, a park.

High-level and programming languages and environments exist which provide tools for a developer which may be a professional or an expert in the specific domain to develop the business logic of such applications without having to write computer code. However, domain experts do not necessarily know how to deal with spatial or spatio-temporal relations aspects, as they may not possess geometric or geospatial background, which may cause difficulties in introducing such aspects to applications. Even further, multiple relations or rules may be involved in any such scenario. Further still, the expressive power of a language used by the domain experts to define the business rule may not be sufficient to precisely define the desired relationships, in a manner that is coherent to the domain expert and definite for the program to interpret.

Introducing these aspects in a textual manner may be awkward and inconvenient. Moreover, multiple developers may describe such relationships in incompatible manner, using for example different vocabulary or different prepositions. Moreover, any such manner may be incompatible with how other parts of the application may need to receive the information. Additionally, such manner may not be definite and precise to provide for a single identifiable relationship as the definition may be ambiguous.

On a higher level, there may be incompatibility between the manners in which different applications expect to receive the relationship descriptions. Such incompatibility may inhibit data sharing or transfer, or using experience gathered in developing one application towards efficient development of another application.

Currently existing visual programming techniques do not provide relevant tools for describing spatial or spatio-temporal relations either.

One technical solution relates to method and a visual and interactive system with which a user can graphically describe spatial or spatio-temporal relations between objects. In some exemplary embodiments, the system may comprise user interface that comprises a canvas pane upon which the user can draw or indicate objects, and a textual pane which may display textual description or textual rules describing the spatio-temporal relations between the drawn objects. A user may initiate a session in which the user may draw and may annotate one or more objects, representing for example persons, areas, tools or the like. The user may also describe one or more objects at multiple points of time thus providing temporal information relating to the same object at different time points.

The system may then suggest one or more options for a relation or rule describing the situation. The rules may have different meanings, and the user may select a rule complying with what she meant. In some cases, some of the two or more rules may have different phrasing but identical meaning, and the user may select the phrasing she prefers.

The system may prompt the user to enter one or more parameters required for the rules, such as a distance, a time difference, or the like, where applicable.

Once the user approves the textual representation of the relations, the system may create corresponding rule, data structures or other representations and may store them. The textual representation, rule or data structures may be stored with the corresponding graphic representation such that the user can continue the session at another time, load it for easily developing another application or for modifying the relations as part of debugging process or specification modification, or export it for any other purpose.

One technical effect of the disclosure relates to providing domain experts with the tools to describe complex spatio-temporal relations between two or more objects, without having to program or to phrase complex textual rules, but rather via an intuitive, graphic interactive user interface.

Another technical effect of the disclosure relates to enabling uniform description of spatial or spatio-temporal situations within an application, and cross-applications, regardless how many developers are contributing to the tasks and of their skills in this area.

Yet another technical effect may be to provide for a precise and definite rule using graphical tool that may be ambiguous on their face. Any ambiguity may be resolved during initial interpretation of the illustration into a rule.

In some cases, logic related to geometry and topologic relationships naturally may be easier to comprehend using visualization. The disclosed subject matter may enable usage of such visualization to define business rules.

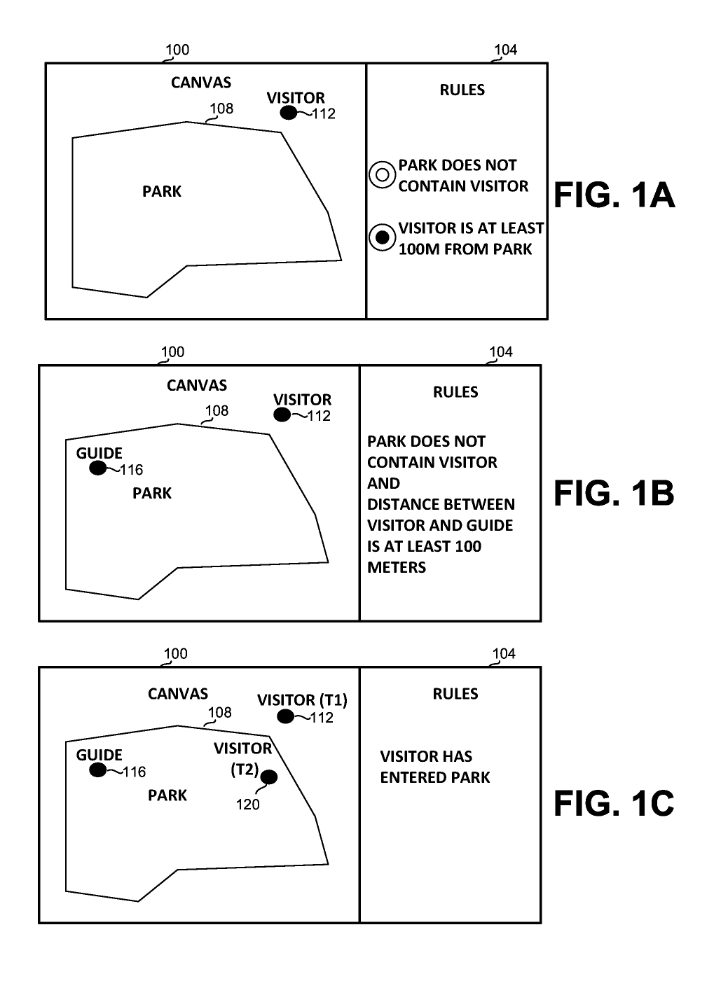

Referring now to FIGS. 1A-1C, showing user interfaces displaying exemplary relations between objects, and corresponding relations or relation suggestions, in accordance with some exemplary embodiments of the subject matter exemplary.

FIG. 1A shows user interface of a computer program, including Canvas Pane 100 and Relations Pane 104. The user has drawn on, or imported into Canvas Pane 100 the objects of Park 108 and Visitor 112, and has annotated them. Alternatively, the user may have imported them with these names or has changed their names

The system may then analyze that a first object (Visitor 112) is external to an object having an area property (Park 108) and may then suggest the following relations by displaying text on Relations Pane 104: A. “Visitor is out of park” and B. “visitor is at least <number><units> from park”. If the user selects option B, she may be prompted to enter the number and units. It will be appreciated that relation A may also be phrased as “Visitor is not inside park”, wherein although the meaning may be the same as option A, some users may prefer one version over the other.

In some exemplary embodiments, a distance relationship (not shown) may be visually indicated between the Visitor 112 and Park 108 to indicate the rule includes a distance relationship between the two objects. In some cases, the distance relationship may be interpreted as “at least <number><units> from”, or “no more than <number><units> from”.

FIG. 1B shows the same situation as FIG. 1A, with an additional object named Guide 116. A suggested relation may then express relationships between the three objects, such as “park does not contain visitor and distance between visitor and guide is at least <number><units>”, wherein the user, after selecting the rule may provide the number and the units.

FIG. 1C shows the same situation as FIG. 1B, wherein the visitor is depicted in two points in time. For example, at point T1 the visitor is denoted 112 and at point T2 the visitor is denoted 120. If, in an exemplary case the user indicates that T1 precedes T2, then the system may then suggest a relation “visitor has entered park”, wherein if T2 preceded T1 the suggested relations may include “visitor has exited park”. Further relations may relate to an exact time at which the user entered or exited the park, to the difference between T1 and T2, or the like.

In some cases, if a relationship between Guide 116 and Visitor 108 is visually indicated, it may be determined that Guide 116 relates to T1 time point. If, however, the relationship between two objects is irrespective of the time, such as a relationship between Guide 116 and Park 108, the time point may be either not relevant or, if relevant, indicated by the user. For example, FIG. 1C may depict “visitor has entered park and guide is inside park at some point” or “visitor has entered park and guide is inside park at the same time as visitor”. In some cases, explicit indication of the point in time may be provided in Canvas Pane 100, such as by indicating for Guide 116 the time T1 or T2.

Any two or more of the described relations may be combined using one or more Boolean operators such as AND, OR, XOR, or the like.

It will be appreciated that combinations of the three cases demonstrated in FIGS. 1A-1C may occur, in which rules may involve three or more objects at a multiplicity of times.

It will also be appreciated that one or more objects, and in particular their respective shapes, may be imported from different sources, such as a geographic database, a Computer Aided Design (CAD) database, or the like. In some exemplary embodiments, the properties of the objects are illustrated in the Canvas Pane 100 schematically. For example, the area property of Park 108 may be different than depicted in Canvas Pane 100, such as it may be a polygon shape, a circle, or the like.

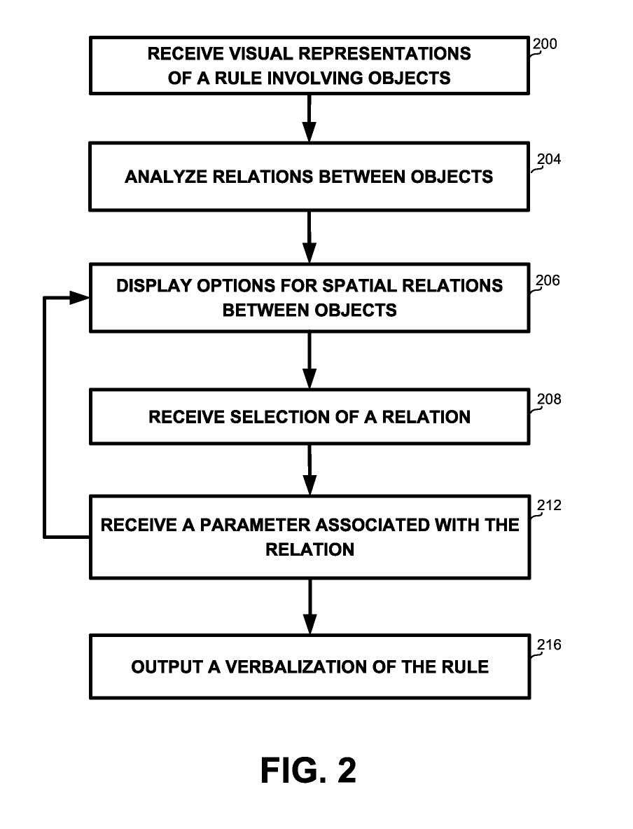

Referring now to FIG. 2A, showing a flowchart of steps in a first embodiment of a method for describing spatio-temporal relations, in accordance with some exemplary embodiments of the disclosure.

On Step 200, a visual representation of a rule involving objects may be received. The visual representation may be drawn using drawing tools similar to those available in common graphic environments, imported from an external source, or drafted schematically if there is no particular importance to the exact shape. It may be indicated whether an object has an area, or if an object is associated with a specific location. The visual representation may include a notation for one or more objects, such as a name, an identifier, or the like.

It will be appreciated that each object may be associated with one or more properties. Additionally or alternatively, the visual representation may be associated with one or more graphic properties, such as color, width, or the like.

In some exemplary embodiments, the visual representation of the rule may include a plurality of visual representation of an object in at least two states occurring at different times. In some cases, a time property of an instance of an object may define a time point at which the instance is to be referred to.

In the following steps, a verbalization of the rule may be generated automatically or semi-automatically.

On Step 204, the relationships between any two or more objects may be analyzed automatically. Based on the analysis, and one or more textual representations or expressions may be determined for the relationship. Optionally, one or more alternative textual representations of the rule may be generated. The relationship may be spatial relationship such as for example which object is inside/outside/above/near/etc. another object. Additionally or alternatively, in case there's at least one object with temporal annotation, the relationship may be temporal. For example, a relationship may include indication of the distance between two of the objects when both are inside or outside the third objects, an object entering or exiting an area of another object, a distance between two or more objects has changed, a first object met with a second object or was in the vicinity thereof, or the like. The potential relationships may be any geographical relationship, temporal relationship, combination thereof with or without additional relationships, or the like. In some exemplary embodiments, the rule may comprise additional logical predicates such as “AND”, “OR”, “XOR”, or the like, used to create composite expressions within a rule.

In some exemplary embodiments, alternative interpretation of a relationship may also be caused due to alternative relative order between the different points in time, which may be different in different interpretations.

In some exemplary embodiments, a decision tree may be generated based on all s possible conflicting interpretation of the relationships. For example, if a single relationship may be represented as A or as B, a decision node may be introduced to the decision tree. Based on the resolution of such conflict, additional conflicts may arise relating thereof or to additional relationships. The resolution may be manual as is exemplified below. However, in some cases, automatic tools may be used to perform automatic resolutions, such as crowd-sourcing, machine learning and artificial intelligence tools, or the like.

On Steps 206-212, manual resolution of conflicting interpretations of the visual representation is depicted. In some exemplary embodiments, a decision tree generated in Step 204 may be traversed, starting at a root node, and with each non-leaf node, performing Steps 206-212, to select a successor node until reaching a leaf node. Options of successor nodes may be presented, such as by presenting a different verbal representation of the relationship for each potential successor node (206). A selection made by the user may be received (208), indicating one of the displayed options for relations. In some exemplary embodiments, the option may be parameterized, such as allowing the introduction of number, data type, or the like, relating to the relationship. The parameter may also be received from a user (212). As an example, a value of a distance parameter may be set. Additionally or alternatively, the parameter may be extracted from the visual representation, such as from metadata of a visual object. Referring again to the distance parameter, the value thereof may be obtained from metadata of an object representing distance and having a metadata indicating the distance value. For example, an arrow between two objects having a name “500” may be interpreted as setting the value 500 for the distance parameter. In some exemplary embodiments, the parameters may relate to temporal properties such as but not limited to the relative order between the different points in time, absolute difference between some or all of the different points in time, absolute time for any of the points, or the like. For example, T1 may be set to occur 30 minutes before T2. As another example, T1 may be set to occur at least 30 minutes before T2.

In some exemplary embodiments, on Step 208 if the user is not content with any of the displayed options, the user may suggest another option by alternative verbalization of the relationship. The text may be reviewed by a professional such as a programmer and a compatible option may be added when analyzing similar situations in the future.

Upon completion of the resolution of all contradicting interpretations, a verbal representation of the rule, which was provided in visual form may be provided. The verbalization may be outputted (216).

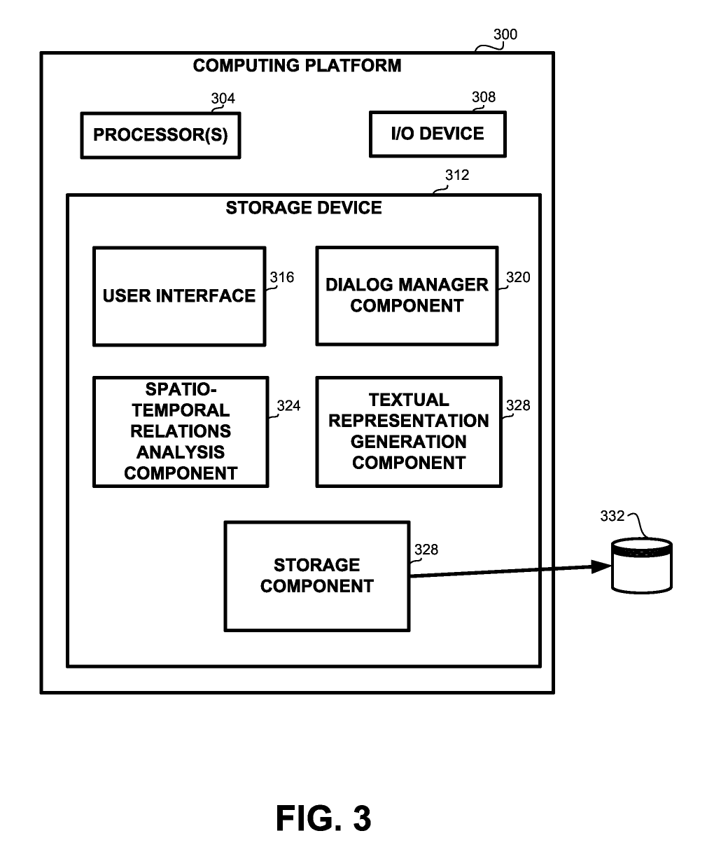

Referring now to FIG. 3, showing an apparatus 300 for describing spatio-temporal rules, in accordance with some exemplary embodiments of the disclosure.

Apparatus 300 may be a computing device, such as a server, a desktop computer, a laptop computer, a mobile device, or the like. Apparatus 300 comprise one or more processor(s) 304. Processor 304 may be a Central Processing Unit (CPU), a microprocessor, an electronic circuit, an Integrated Circuit (IC) or the like. Processor 304 may be utilized to perform computations required by Apparatus 300 or any of it subcomponents.

In some exemplary embodiments of the disclosed subject matter, Apparatus 300 may comprise an Input/Output (I/O) Device 308 such as a display, a pointing device, a keyboard, a touch screen, or the like. I/O Device 308 may be utilized to provide output to and receive input from a user.

In some exemplary embodiments, Apparatus 300 may comprise a Storage Device 312. Storage Device 312 may be a hard disk drive, a Flash disk, a Random Access Memory (RAM), a memory chip, or the like. In some exemplary embodiments, Storage Device 312 may retain program code operative to cause Processor 304 to perform acts associated with any of the subcomponents of Apparatus 300. The components detailed below may be implemented as one or more sets of interrelated computer instructions, executed for example by Processor 304 or by another processor. The components may be arranged as one or more executable files, dynamic libraries, static libraries, methods, functions, services, or the like, programmed in any programming language and under any computing environment.

Storage Device 312 may comprise User Interface Module 316 using which a user may enter information such as draw or select shapes, enter names, view suggested relations, select a relation, enter parameters, or the like. UI Module 316 may provide for a graphical user interface with which the user can interact, in accordance with the s disclosed subject matter. UI Module 316 may facilitate a canvas pane, a relations pane, or the like. UI Module 316 may allow a user to provide a schematic illustration of a desired spatial rule, which may or may not involve temporal relationships.

Storage Device 312 may comprise a Dialog Manager Component 320 for managing a dialog with the user, for example receiving user input and selections, providing suggested options, or the like. In some exemplary embodiments, Dialog Manager Component 320 may be configured to display options and receive selections through a relations pane. Additionally or alternatively, Dialog Manager Component 320 may be configured to display a compact representation of the decision tree. In some exemplary embodiments, the current path from the root node to the current analyzed node and the representations of the multiple potential successive nodes may be presented. The user may be able to revoke her previous decisions by selecting a node in the path, thereby undoing every selection made between the selected node and the currently examined node.

Storage Device 312 may comprise Spatio-Temporal Relations Analysis Component 324 for determining spatial and spatio-temporal relationships between objects used to illustrate a business rule. In some exemplary embodiments, Spatio-Temporal Relations Analysis Component 324 may be configured to generate a decision tree used for verbalization of the graphical rule.

Storage Device 312 may comprise Textual Representation Generation Component 328 for generating one or more alternative strings representing a relationship. The alternative strings may or may not be parametric. The strings may be included in the decision tree generated by Spatio-Temporal Relations Analysis Component 324.

Storage Device 312 may comprise or be in communication with Database 332 for storing a representation of the relations between objects. The representation may include the graphical representation, the textual representation, data structures, or the like.

### AN EMBODIMENT

A tool in accordance with the disclosed subject matter may comprise two views: a geometric/topologic (or canvas) view, and a code view which presents the expression using a target expression language, such as for example and without limitation IBM's Operational Decision Manager (ODM) business rule language. A scenario presented on the canvas may be translated to a textual rule in a target expression language. An interactive engine may be used for such process. The engine may recognize geometric and topologic relationship on the canvas and match predefined rules that relate to them. For example, if two points are drawn, then a rule that relates to their distance could be matched. Next, the user is given a list of choices to choose from. For instance, if a point is drawn inside a polygon, two possible matches may be a rule that relate to the containment of the point and another one could be the distance of the point to the boundary of the polygon. If the set of rules is rich, a possible sequence of choices may be defined. For instance, once the user chooses distance among three entities, she may choose the specific kind of distance (e.g., the maximum distance to one of the elements or the sum of distances). Another choice could be the distance metric (e.g., Euclidean vs. Manhattan). In this process, the user may also choose corresponding constants (e.g., the distance between the elements). In many cases also using Boolean operations such as ‘and’ or ‘or’ may be supported. The translation process may be defined by a tree-like structure where in each step the user chooses where to descend in the tree. The leaves of the tree hold the final verbalization.

More specifically, the process may be carried out as follow. The user may first work on the canvas by drawing geometries and annotations, such as names of the entities, their spatio-tempora index, or the like, that describe the scenario. In a next step, the user may initiate the translation process. Then she may go through an iterative process in which she selects choices and enters parameter values as described above.

Consider an example where a visual diagram shows three types of application objects—a visitor, a guide, and a park. Every object has an associated geometric shape: visitors and guides are points whereas parks are polygons. The types of objects and their associated geometry types are described by the application model (e.g., the ODM Business Object Model) that is used to build the visual view. The relationships that were discovered by a spatiotemporal mining algorithm implemented by the translation engine may include, for example, the following:

1. The polygon contains the location of the guide;
2. The polygon does not contain the location of the visitor;
3. The distance between the locations of the visitor and the guide is <DISTANCE>.

In some exemplary embodiments, the engine may also discover additional predicates which the user can select to ignore. The selected predicates may be encoded using the Business Rule Language, and the resulting expression may appear in the code view.

The disclosed subject matter may also cover temporality. Spatial entities may be referred to in different times. Temporality may be visualized by drawing entities many times, each with a different index that indicates a point in time where the entity has been. Then the translation to the verbalization could be with keywords like ‘before’, ‘after’ and so on.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

What is claimed is:

1. A computer-implemented method comprising:
receiving a visual representation of rule, the visual representation comprising two or more objects;
analyzing a spatial relationship appearing in the visual representation of the rule, wherein said analyzing comprises determining multiple alternative textual representations for the spatial relationship;
receiving from a user a selection between the multiple alternative textual representations of the spatial relationship, whereby obtaining a selected verbalization of the relationship; and
generating a verbalization of the rule, wherein the verbalization comprises the selected verbalization of the relationship.

2. The method of claim 1, wherein the selected verbalization is a parametric verbalization, wherein the method further comprises receiving a value for a parameter of the parametric verbalization.

3. The method of claim 2, wherein the parameter is a distance parameter.

4. The method of claim 1, wherein the visual representation comprises temporal index indication for at least one object, wherein the spatial relationship is a spatio-temporal relationship.

5. The method of claim 1, wherein said analyzing comprises generating a decision tree, wherein the decision tree comprises nodes, wherein non-leaf nodes represent relationships appearing in the visual representation of the rule that have two or more alternative textual representations; wherein said receiving from the user the selection is performed repeatedly to determine a path between a root node of the decision tree and a leaf node of the decision tree, wherein each selection is a selection between multiple alternative textual representations associated with successive nodes of a current node, whereby a the verbalization of the rule is generated based on a user-guided traversal of the decision tree.

6. A computerized apparatus having a processor, the processor being adapted to perform the steps of:
receiving a visual representation of rule, the visual representation comprising two or more objects;
analyzing a spatial relationship appearing in the visual representation of the rule, wherein said analyzing comprises determining multiple alternative textual representations for the spatial relationship;
receiving from a user a selection between the multiple alternative textual representations of the spatial relationship, whereby obtaining a selected verbalization of the relationship; and
generating a verbalization of the rule, wherein the verbalization comprises the selected verbalization of the relationship.

7. The computerized apparatus of claim 6, wherein the selected verbalization is a parametric verbalization, wherein the method further comprises receiving a value for a parameter of the parametric verbalization.

8. The computerized apparatus of claim 7, wherein the parameter is a distance parameter.

9. The computerized apparatus of claim 6, wherein the visual representation comprises temporal index indication for at least one object, wherein the spatial relationship is a spatio-temporal relationship.

10. The computerized apparatus of claim 6, wherein said analyzing comprises generating a decision tree, wherein the decision tree comprises nodes, wherein non-leaf nodes represent relationships appearing in the visual representation of the rule that have two or more alternative textual representations; wherein said receiving from the user the selection is performed repeatedly to determine a path between a root node of the decision tree and a leaf node of the decision tree, wherein each selection is a selection between multiple alternative textual representations associated with successive nodes of a current node, whereby a the verbalization of the rule is generated based on a user-guided traversal of the decision tree.

11. A computer program product comprising a non-transitory computer readable storage medium retaining program instructions, which program instructions when read by a processor, cause the processor to perform a method comprising:
receiving a visual representation of rule, the visual representation comprising two or more objects;
analyzing a spatial relationship appearing in the visual representation of the rule, wherein said analyzing comprises determining multiple alternative textual representations for the spatial relationship;
receiving from a user a selection between the multiple alternative textual representations of the spatial relationship, whereby obtaining a selected verbalization of the relationship; and
generating a verbalization of the rule, wherein the verbalization comprises the selected verbalization of the relationship.

12. The computer program product of claim 11, wherein the selected verbalization is a parametric verbalization, wherein the method further comprises receiving a value for a parameter of the parametric verbalization.

13. The computer program product of claim 12, wherein the parameter is a distance parameter.

14. The computer program product of claim 11, wherein the visual representation comprises temporal index indication for at least one object, wherein the spatial relationship is a spatio-temporal relationship.

15. The computer program product of claim 11, wherein said analyzing comprises generating a decision tree, wherein the decision tree comprises nodes, wherein non-leaf nodes represent relationships appearing in the visual representation of the rule that have two or more alternative textual representations; wherein said receiving from the user the selection is performed repeatedly to determine a path between a root node of the decision tree and a leaf node of the decision tree, wherein each selection is a selection between multiple alternative textual representations associated with successive nodes of a current node, whereby a the verbalization of the rule is generated based on a user-guided traversal of the decision tree.
